(19) United States
(12) Patent Application Publication
(10) Pub. No.: US 2026/0251487 A1
(43) Pub. Date: Aug. 27, 2026

(54) COMPACT MAINTENANCE ASSEMBLY FOR A PROCESS MEASURING SYSTEM

(71) Applicant: Dieterich Standard, Inc, Boulder, CO (US)

(72) Inventor: Nathaniel Kirk Kenyon, Westminster, CO (US)

(21) Appl. No.: 19/065,330

(22) Filed: Feb. 27, 2025

(51) Int. Cl. G01F 15/00; G01F 1/36

(52) U.S. Cl. CPC G01F 15/00; G01F 1/36

(57) ABSTRACT

A system for measuring process fluid flow includes a pressure transmitter, at least one remote seal, at least one compact saddle flange coupled to a fluid flow and at least one compact maintenance assembly. The compact maintenance assembly includes a footer having a flange that is coupled to the at least one compact saddle flange and a flange-less header having at least one flushing port and being coupled to the at least one remote seal. The at least one flushing port includes a channel that extends from an outer surface of the flange-less header to an inner surface of the flange-less header.

### BACKGROUND

The present invention is related to industrial process control and measurement devices. More particularly, the invention is related to a device that measures fluid flow of a process fluid.

Field devices, such as process variable transmitters, are used by a number of industries to remotely sense or control a process variable. Such process variables are generally associated with fluids such as slurries, liquids, vapors, gasses, chemicals, pulp, petroleum, pharmaceuticals, food and other fluid processing plants. Process variables may include pressure, temperature, flow, turbidity, density, concentration, chemical compensation and other properties. Other examples of field devices include valves, actuators, heaters and controllers.

An industrial process fluid flow measurement device generally requires multiple components. For example, one type of process fluid flow transmitter includes a fluid obstruction device disposed in the fluid flow within a conduit. The process flow transmitter then measures a differential pressure before and after the fluid obstruction device, such as an orifice plate, v-cone, or conditioning orifice plate, in the fluid conduit and calculates the mass or volumetric flow of the fluid passing therethrough. The fluid obstruction device causes a differential pressure to be developed between the upstream and downstream sides of the obstruction, which is related to the flow rate of the fluid. The process variable fluid flow transmitter then conveys the fluid flow information to a process controller, which may be a computer located in a control room, or even another field device mounted in the field.

Wedge flow meters are generally used for measuring the flow of abrasive, viscous and erosive fluids. Wedge flow meters include two branched pressure ports that transmit high and low pressures on either side of a fluid obstruction device or element that has a wedge shape to restrict and generate a differential pressure (DP) signal in spool of pipe. Instrument branches transmit the differential pressure signal to a differential pressure transmitter generally through remote seals.

### SUMMARY

According to some aspects of this description, a system for measuring process fluid flow includes a differential pressure flowmeter configured to constrict fluid flow and has an inlet, an outlet, a first saddle flange on a downstream side of the constricted fluid flow and a second saddle flange on an upstream side of the constricted fluid flow. First and second maintenance assemblies are coupled to the flowmeter. First and second remote seals are coupled to respective first and second maintenance assemblies. A differential pressure transmitter is fluidically coupled to the first and second remote seals. The first maintenance assembly includes a first footer having a flange that couples to the first saddle flange of the flowmeter and a first flange-less header having at least one flushing port and being coupled to the first remote seal. The second maintenance assembly includes a second footer having a flange that couples to the second saddle flange of the flowmeter and a second flange-less header having at least one flushing port and being coupled to the second remote seal.

According to some aspects of this description, a system for measuring process fluid flow includes a pressure transmitter, at least one remote seal, at least one compact saddle flange coupled to a fluid flow and at least one compact maintenance assembly. The at least one compact maintenance assembly includes a flanged footer and a flange-less header. The flanged footer is coupled to the at least one compact saddle flange. The flange-less header has at least one flushing port and is coupled to the at least one remote seal. The at least one flushing port includes a channel that extends from an outer surface of the flange-less header to an inner surface of the flange-less header.

According to some aspects of this description, a compact maintenance assembly of a system for measuring process fluid flow includes a footer having a flange and a flange-less header. The flange of the footer includes a plurality of radially arranged apertures that extend from a first surface of the flange to a second opposing surface of the flange. Each aperture is configured to receive a fastener to attach to a compact saddle flange. The flange-less header includes a plurality of radially arranged apertures that extend internally through a thickness of the flange-less header from a first surface of the flange-less header to a second opposing surface of the flange-less header and are configured to receive a plurality of fasteners to attach to a remote seal. The flange-less header further includes at least one flushing port that extends from an inner surface of the flange-less header to an outer surface of the flange-less header.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 illustrates a schematic diagram of a system for measuring process fluid flow including a wedge flowmeter having a fluid flow conduit with an inlet and an outlet and a differential pressure transmitter.

FIG. 2 illustrates a perspective view of a wedge flowmeter with compact saddle flange connections.

FIG. 3 illustrates a perspective view of a compact maintenance assembly according to an embodiment.

FIG. 4 illustrates a perspective view of a flanged footer of the compact maintenance assembly of FIG. 3.

FIG. 5 illustrates a top view of the flanged footer of FIG. 4.

FIG. 6 illustrates a section view of the flanged footer of FIG. 4 taken through the section line indicated in FIG. 5.

FIG. 7 illustrates a perspective view of a flange-less header of the remote seal system of FIG. 3.

FIG. 8 illustrates a top view of the flange-less header of FIG. 7.

FIG. 9 illustrates a section view of the flange-less header of FIG. 7 taken through the section line indicated in FIG. 8.

FIG. 10 illustrates a section view of the flange-less header taken through the section line indicated in FIG. 8.

FIG. 11 illustrates a perspective view of a system for measuring process fluid flow according to an embodiment.

FIG. 12 illustrates an exploded view of FIG. 11.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations. The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

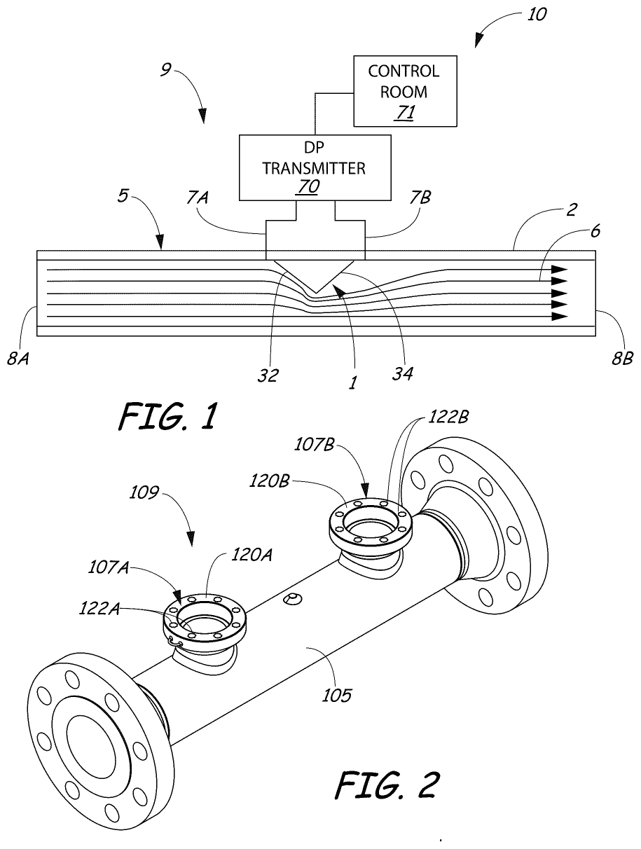

FIG. 1 illustrates a schematic diagram of a system 10 for measuring process fluid flow including a differential pressure flowmeter, such as a wedge flowmeter or pipe spool meter 9, having a fluid flow conduit 5, such as a pipe, with an inlet and an outlet and a differential pressure transmitter 70. Flowmeter 9 is configured to measure process variables of a flow of process fluid, for example, abrasive, viscous and erosive fluids. A fluid flow obstruction device 1, embodied as a wedge element, is arranged and installed within a body 2 of fluid flow conduit 5. As illustrated in FIG. 1, process fluid is shown to flow 6 in a direction from an inlet 8A to an outlet 8B of the fluid flow conduit 5. The constriction introduced by the fluid flow obstruction device 1 results in a differential pressure (DP) between each side of fluid flow obstruction device 1. Flowmeter 9 includes two or more branches that split off the main run of pipe spool and are configured to transmit the differential pressure signal, i.e. high-pressure signal through connection 7A and low-pressure signal through connection 7B, to differential pressure transmitter 70. The differential pressure (DP) is related to flow rate and is measured by differential pressure (DP) transmitter 70, which conveys the fluid flow information to a process controller in, for example, a control room 71 and is translated to a flow rate measurement.

There are different transmitter connection styles that may be used at connection 7A and connection 7B. Saddle-style connections provide a light-weight design and are considered to be compact. Such a compact saddle-style reduces pipe stand off to address plugging and cleaning concerns. Flanged-style connections are a traditional style that uses, for example, a nominal pipe size (NPS) of 2 or a diameter nominal (DN) size of 50 mm. This traditional style is used when flushing rings and valve assemblies are required so that residue build up from remote seals may be removed without disconnecting remote seals from the process. Flushing rings result in less downtime, less labor and less parts to manage. Threaded-style connections use, for example, a ½ inch National Pipe Tapered (NPT) with tubing and is ideal for applications where plugging is less of a concern than erosion or wear.

FIG. 2 illustrates a perspective view of a wedge flowmeter 109 with a pair of saddle-style connections 107A and 107B that transmit differential pressure signals. As described above, saddle-style connections 107A and 107B are compact in design and reduce pipe stand off to address plugging and cleaning concerns, however, are not designed to incorporate flushing rings. Each saddle or compact saddle connection 107A and 107B is coupled to pipe 105 by, for example, welding, and includes a saddle-style or compact saddle flange 120A and 120B having a plurality of apertures 122A and 122B radially arranged about and extending through compact saddle flanges 120A and 120B, respectively. Each compact saddle flange 120A and 120B is configured to receive a remote seal (not illustrated in FIG. 2). Each remote seal is directly attached to each compact saddle flange 120A and 120B with fasteners or bolts (not illustrated in FIG. 2) that screw into flanges 120A or 120B. Each remote seal (not illustrated in FIG. 2) is coupled to a differential pressure transmitter (not illustrated in FIG. 2) with capillary tubes. As previously stated, such a configuration of flow measurement as described above and as partially illustrated in FIG. 2, however, does not include any maintenance capabilities while the process fluid system is running including isolating the differential pressure transmitter from process fluid to vent, drain or calibrate and flushing or removing build up from the space around the diaphragm of the remote seal without disconnecting the remote seal.

While it is possible to try and place a flushing ring between a flanged branch of a wedge flowmeter and a remote seal in a compact saddle-style connection to remove build up from the space around the diaphragm of the remote seal, the flushing ring would take up an excessive amount of space, requires extra gaskets and the radially arranged fastener or bolt configuration would extend between the remote seal and the flanged branch, causing restrictive access to the flushing ports on the flushing ring. Not only do tools, such as socket wrenches, need to be used to remove flushing port plugs from flushing rings, but tools that provide pneumatic pressure to clear out the viscous fluid are also required. As described above, traditional flanged-style connections rather than compact saddle connections are equipped and designed to include flushing rings having flushing ports.

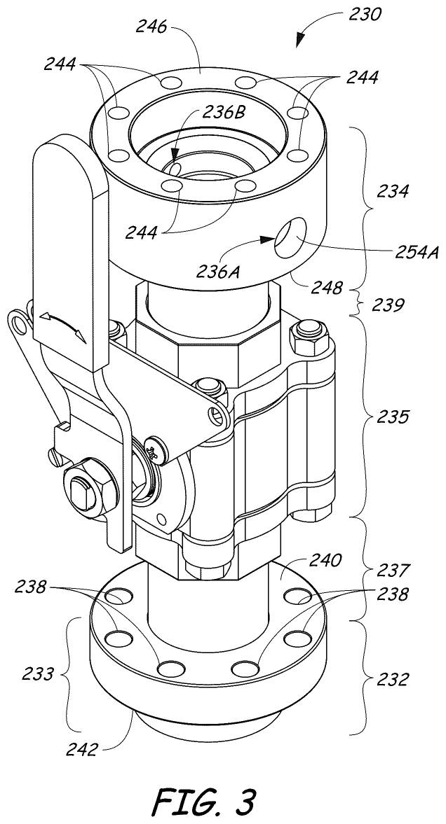

FIG. 3 illustrates a perspective view of a maintenance assembly 230 according to an embodiment. Maintenance assembly or compact maintenance assembly 230 includes flushing ports and is configured for use and incorporation with saddle-style or compact saddle connections and eliminates the detriments of incorporating a flushing ring into a compact saddle-style connection as described above. Compact maintenance assembly 230 includes a footer 232, a header 234 and an optional isolation valve 235 located between footer 232 and header 234. In FIG. 3, isolation valve 235 is coupled to footer 232 by a first nipple section 237 and is coupled to header 234 by a second nipple section 239.

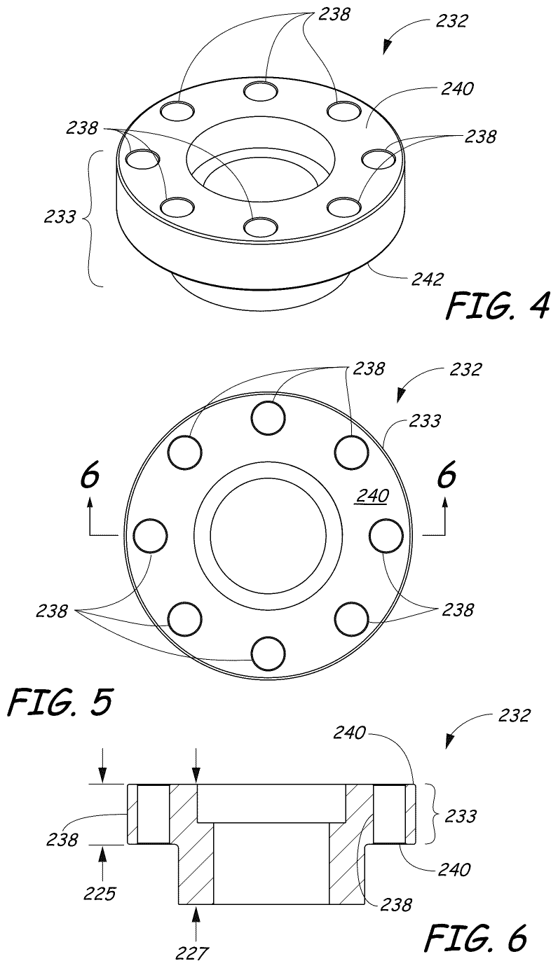

FIG. 4 illustrates a perspective view of footer 232 of compact maintenance assembly 230, FIG. 5 illustrates a top view of footer 232 and FIG. 6 illustrates a section view of footer 232 taken through the section line indicated in FIG. 5. Footer 232 is a flanged footer and includes an integrally formed flange 233 having a flange thickness 225 that is thinner than an entire body thickness 227. Flange 233 includes a plurality of radially arranged apertures 238 that extend from a first surface 240 of flange 233 to an opposing second surface 242 of flange 233. Each of the radially arranged apertures 238 are configured to receive a fastener or bolt to directly attach footer 232 to one of the compact saddle flanges 120A or 120B of FIG. 2.

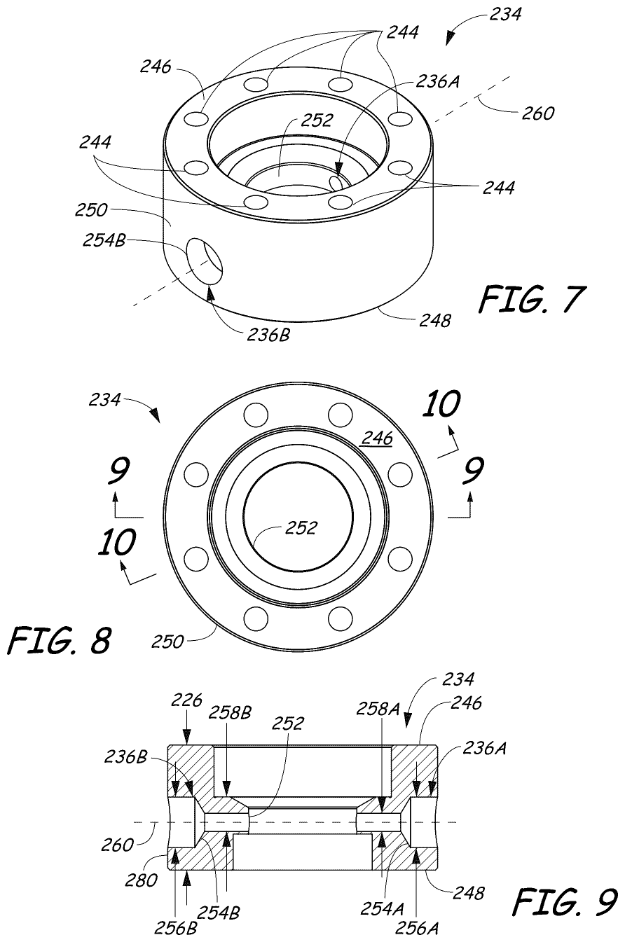

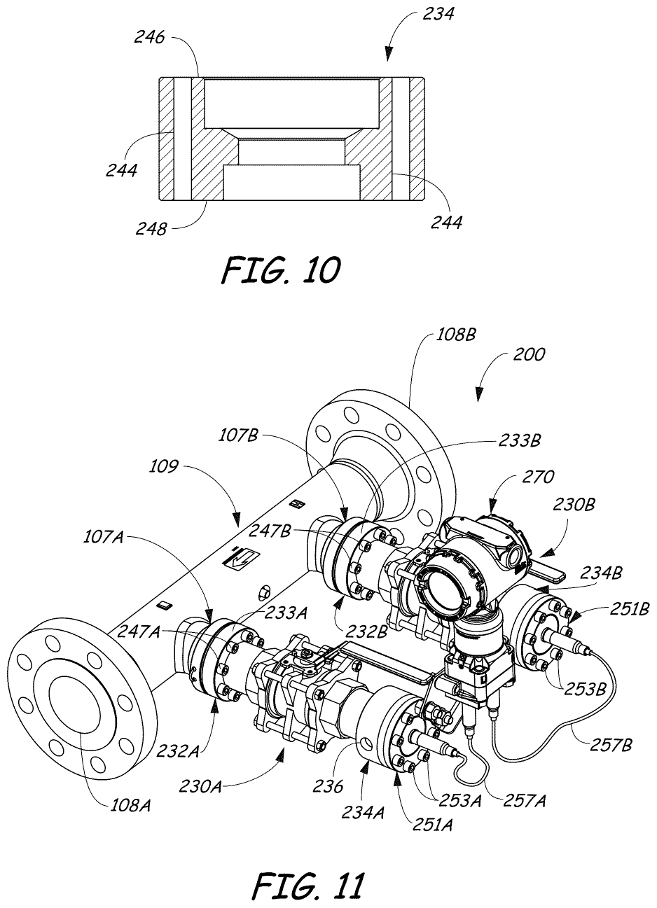

FIG. 7 illustrates a perspective view of header 234 of compact maintenance assembly 230, FIG. 8 illustrates a top view of header 234, FIG. 9 illustrates a section view of header 234 taken through the section line indicated in FIG. 8 and FIG. 10 illustrates a section view of header 234 taken through the section line indicated in FIG. 8. Header 234 is a flange-less header and includes a uniform thickness 226 that is defined between first surface 246 and opposing second surface 248. Flange-less header 234 with uniform thickness 226 includes a plurality of radially arranged apertures 244 that extend from first surface 246 to opposing second surface 248. Each of the radially arranged apertures 244 are configured to receive a fastener or bolt to directly attach flange-less header 234 to a remote seal.

Flange-less header 234 with uniform thickness 226 includes enough material to also include at least one flushing port 236A that extends from an outer surface 250 of flange-less header 234 to an inner surface 252 of flange-less header 234 without compromise. As illustrated in FIGS. 3 and 7-10, flange-less header 234 includes a pair of flushing ports 236A and 236B each having a channel 254A and 254B that extends from outer surface 252 to inner surface 250 and each channel 254A and 254B of the pair of flushing ports 236A and 236B extend along a shared axis 260. As described above, flushing ports 236A and 236B are used to remove build up from the space around the diaphragm of the remote seal without disconnecting the remote seal. First flushing port 236A includes channel 254A that has a first diameter 256A at outer surface 250 that is greater than a second diameter 258A at inner surface 252. Second flushing port 236B includes channel 254B that has a first diameter 256B at outer surface 250 that is greater than a second diameter 258B at inner surface 252. It should be realized that each of the plurality of apertures 244 of header 234 are spaced apart from each other and are non-intersecting with each of the pair of flushing ports 236A and 236B. Plugs may be used to close off the flushing ports when the ports are not in use.

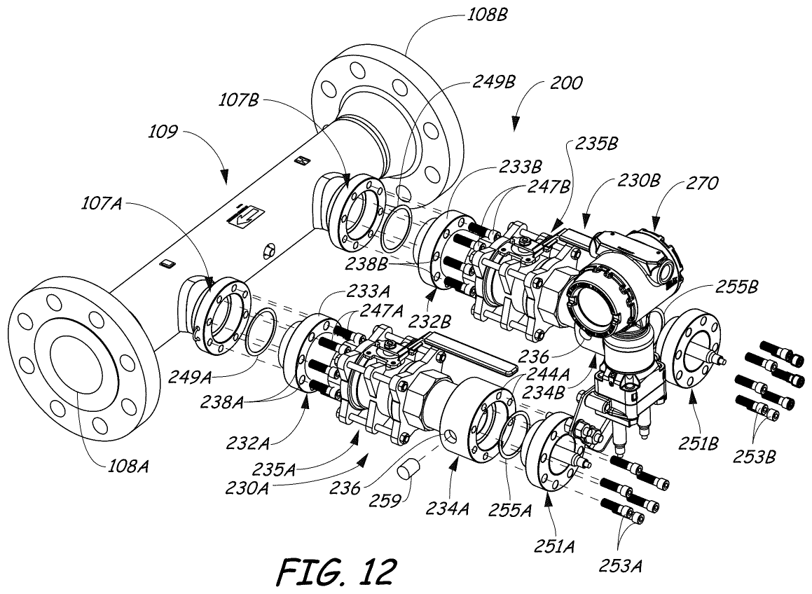

FIG. 11 illustrates a perspective view of a process measuring system 200 for measuring process fluid flow according to an embodiment. FIG. 12 illustrates an exploded view of FIG. 11. Process measuring system 200 includes a differential pressure flowmeter, such as a wedge flowmeter 109, that constricts fluid flow and includes an inlet 108A, an outlet 108B, a first compact saddle connection or flange 107A and a second compact saddle connection of flange 107B. First compact saddle flange 107A is on an upstream side of constricted fluid flow and second compact saddle flange 107B is on a downstream side of constricted fluid flow. The process measuring system 200 further includes a pair of first and second compact maintenance assemblies 230A and 230B illustrated in FIG. 3, a pair of first and second remote seals 251A and 251B and a differential pressure transmitter 270. The pair of compact maintenance assemblies 230 and 230B are coupled to flowmeter 109, the first and second remote seals 251A and 251B are coupled to first and second compact maintenance assemblies 230A and 230B and differential pressure transmitter 270 is fluidically coupled to first and second remote seals 251A and 251B with, for example and as illustrated in FIG. 11, respective capillary tubes 257A and 257B.

First compact maintenance assembly 230A includes first footer 232A having a flange 233A that is coupled to first compact saddle flange 107A and also includes a first flange-less header 234A that has at least one flushing port 236 and is coupled to first remote seal 251A. Second compact maintenance assembly 230B includes second footer 232B having a flange 233B that is coupled to second compact saddle flange 107B and includes a second flange-less header 234B that has at least one flushing port 236 and is coupled to second remote seal 251B.

As illustrated in FIGS. 11 and 12, flanged footers 232A and 232B of compact maintenance assemblies 230A and 230B are coupled to or attached to respective compact saddle flanges 107A and 107B using radially arranged fasteners or bolts 247A and 247B that fit through apertures 238A and 238B that extend through flanges 233A and 233B and screw into flanges 120A and 120B. Additionally, respective gaskets 249A and 249B are preferably used in the coupling of compact saddle connections 107A and 107B and flanged footers 232A and 232B.

Flange-less headers 234A and 234B of compact maintenance assemblies 230A and 230B are directly coupled to or attached to respective first and second remote seals 251A and 251B that include remote seal flanges using radially arranged fasteners or bolts 253A and 253B that extend through apertures 244A and 244B on respective flange-less headers 234A and 234B and apertures in flanges of respective remote seals 251A and 251B. Additionally, respective gaskets 255A and 255B are used in the coupling of flange-less headers 234A and 234B and remote seals 251A and 251B.

As described above, each flange-less header 234A and 234B includes at least one flushing port 236. Each of the at least one flushing ports 236 includes a removable plug 259 of which one is shown exploded from flushing port 236 in FIG. 12. As illustrated, removable plug 259 is accessible and easily removed to clear out any viscous build up. Each compact maintenance assembly 230A and 230B may further include an isolation valve 235A and 235B located between flanged footers 232A and 232B and flange-less headers 234A and 234B. With each compact maintenance assembly 230A and 230B including an isolation valve 235A and 235B, users of the process measuring system 200 may isolate the diaphragms in remote seals 251A and 251B from the flowmeter 109 to complete any number of maintenance activities without shutting down the process fluid including using flushing ports 236 to flush, clear or clean clogs, replace the remote seals 251A and 251B or differential pressure transmitter 270, perform pressure verification or perform a zero trim.

Although the present invention has been described with reference to preferred embodiments, workers skilled in the art will recognize that changes may be made in form and detail without departing from the spirit and scope of the specification.

What is claimed is:

1. A system for measuring process fluid flow, the system comprising:
a differential pressure flowmeter configured to constrict fluid flow and including an inlet, an outlet, a first saddle flange on a downstream side of the constricted fluid flow and a second saddle flange on an upstream side of the constricted fluid flow;
first and second maintenance assemblies coupled to the flowmeter;
first and second remote seals coupled to respective first and second maintenance assemblies; and
a differential pressure transmitter fluidically coupled to the first and second remote seals; and
wherein the first maintenance assembly includes a first footer having a flange that couples to the first saddle flange of the flowmeter and a first flange-less header having at least one flushing port and being coupled to the first remote seal; and
wherein the second compact maintenance assembly includes a second footer having a flange that couples to the second saddle flange of the flowmeter and a second flange-less header having at least one flushing port and being coupled to the second remote seal.

2. The system of claim 1, wherein each of the at least one flushing ports of each of the first and second flange-less headers comprises:
a channel that extends from an outer surface of the respective first or second flange-less header to an inner surface of the respective first or second flange-less header; and
a removable plug.

3. The system of claim 2, wherein the channel of the at least one flushing ports of each of the first and second flange-less headers comprises a diameter on the outer surface of the respective first or second flange-less header that is greater than a diameter on the inner surface of the respective first or second flange-less header.

4. The system of claim 1, wherein the at least one flushing port of each of the first and second flange-less headers comprises a pair of flushing ports each having a channel that extends from an outer surface of the respective first or second flange-less header to an inner surface of the respective first or second flange-less header, the pair of flushing ports extending along a shared axis.

5. The system of claim 4, wherein each channel of the pair of flushing ports has a diameter on the outer surface of the respective first or second flange-less header that is greater than a diameter on the inner surface of the respective first or second flange-less header.

6. The system of claim 1, wherein each of the first or second flange-less header comprises a plurality of radially arranged apertures that extend internal through a thickness of the respective first or second flange-less header from a first surface to a second opposing surface and each of the plurality of apertures are configured to receive one of a plurality of fasteners to couple the respective first or second flange-less header to the respective first or second remote seal, wherein the plurality of apertures in each of the respective first or second flange-less header are spaced apart from each other and are non-intersecting with the at least one flushing port.

7. The system of claim 6, further comprising an isolation valve located between the footer having the flange and the flange-less header.

8. The system of claim 1, further comprises a single gasket located between the first or second footer of each of the first and second compact maintenance assemblies and each of the first and second compact saddle flanges and a single gasket located between the first or second flange-less header of each of the first and second compact maintenance assemblies and each of the first and second remote seals.

9. A system for measuring process fluid flow, the system comprising:
a pressure transmitter;
at least one remote seal;
at least one compact saddle flange coupled to a fluid flow; and
at least one compact maintenance assembly including a flanged footer coupled to the at least one compact saddle flange and a flange-less header having at least one flushing port and being coupled to the at least one remote seal, wherein the at least one flushing port includes a channel that extends from an outer surface of the flange-less header to an inner surface of the flange-less header.

10. The system of claim 9, wherein the channel of the at least one flushing port has a diameter on the outer surface of the flange-less header that is greater than a diameter on the inner surface of the flange-less header.

11. The system of claim 9, wherein the at least one flushing port of the at least one flange-less header comprises a pair of flushing ports each having a channel that extends from an outer surface of the flange-less header to an inner surface of the flange-less header and each channel extending along a shared axis.

12. The system of claim 9, wherein the at least one flange-less header of the at least one compact maintenance assembly comprises a plurality of radially arranged apertures that extend internally through a thickness of the flange-less header from a first surface to a second opposing surface and each aperture is configured to receive a fastener, wherein the plurality of apertures are spaced apart from each other and are non-intersecting with the at least one flushing port.

13. The system of claim 9, wherein the at least one compact saddle flange comprises a pair of compact saddle flanges, the at least one remote seal comprises a pair of remote seals and at least one compact maintenance assembly comprises a pair of compact maintenance assemblies.

14. The system of claim 9, further comprising an isolation valve located between the flanged footer and the flange-less header.

15. The system of claim 9, further comprises a single gasket located between the flanged footer of the at least one compact maintenance assembly and the at least one compact saddle flange and a single gasket located between the flange-less header of the at least one compact maintenance assembly and the at least one remote seal.

16. A compact maintenance assembly of a system for measuring process fluid flow, the compact maintenance assembly comprising:
a footer including a flange having a plurality of radially arranged apertures that extend from a first surface of the flange to a second opposing surface of the flange, each aperture is configured to receive a fastener to attach to a compact saddle flange; and
a flange-less header including a plurality of radially arranged apertures that extend internally through a thickness of the flange-less header from a first surface of the flange-less header to a second opposing surface of the flange-less header and are configured to receive a plurality of fasteners to attach to a remote seal, wherein the flange-less header further includes at least one flushing port that extends from an inner surface of the flange-less header to an outer surface of the flange-less header.

17. The compact maintenance assembly of claim 16, wherein the at least one flushing port comprises a channel that has first diameter at the outer surface of the flange-less header that is greater than a second diameter at the inner surface of the flange-less header.

18. The compact maintenance assembly of claim 16, wherein the at least one flushing port of the flange-less header comprises a pair of flushing ports each having a channel that extends from an outer surface of the flange-less header to an inner surface of the flange-less header and wherein each channel of the pair of flushing ports extends along a shared axis.

19. The compact maintenance assembly of claim 16, wherein the plurality of apertures of the flange-less header are spaced apart from each other and are non-intersecting with the at least one flushing port.

20. The compact maintenance assembly of claim 16, further comprising an isolation valve located between the footer and the header.
